(19) United States
(12) Patent Application Publication
(10) Pub. No.: US 2006/0234734 A1
(43) Pub. Date: Oct. 19, 2006

(54) System and method for exchanging SMS message

(75) Inventor: Jae-Hyoung Kim, Anyang-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Gyeonggi-do (KR)

(21) Appl. No.: 11/400,978

(22) Filed: Apr. 10, 2006

(30) Foreign Application Priority Data
Apr. 19, 2005 (KR) 2005-32525

(51) Int. Cl. H04Q 7/20

(52) U.S. Cl. 455/466

(57) ABSTRACT

Disclosed is a system and a method for exchanging a short messaging service (SMS) message. To do this, when a sender edits SMS message data which is longer than the length regulated in an SMS message transmission standard, the SMS message data is compressed using Huffman coding and transmitted. A base transceiver station (BTS) connected to a recipient's mobile station (MS), which has received the compressed SMS message data, restores the SMS message data by decoding the compressed SMS message data and transmits the restored SMS message data to the recipient's MS. Accordingly, SMS message data longer than the length regulated in the SMS message transmission standard can be exchanged, and in exchanging of the compressed SMS message data, a processing time of the compressed SMS message data can be reduced, and power consumption of a recipient's MS due to the processing of the compressed SMS message data can be reduced.

### PRIORITY

This application claims priority under 35 U.S.C. §119 to an application entitled “System and Method for Exchanging SMS Message” filed in the Korean Intellectual Property Office on Apr. 19, 2005 and assigned Serial No. 2005-32525, the contents of which are incorporated herein by reference.

### BACKGROUND OF THE INVENTION

1. Field of the Invention

The present invention relates generally to a mobile communication terminal, and in particular, to a Short Messaging Service (SMS).

2. Description of the Related Art

The SMS (which is also known as a short message service) is a text service by which mobile station (MS) users can send and receive short messages without extra devices, In general, for such an SMS message, the amount of data that can be sent at one time is limited to 80 bytes when using communication methods such as a Code Division Multiple Access (CDMA) communication method.

To send individual characters or words formed using one or more characters such as alphabetical, numerical, etc. characters (which can be formed of consonants and/or vowels) using a mobile station (MS), an international standard known as the American Standard Code for Information Interchange (ASCII) code is typically used. The ASCII code defines each possible number, character, and special character (e.g., “*”!, etc.) using a codestream of 8 bits (i.e., a 1 byte word). Thus, for MSs, a short message is transmitted between MS users by exchanging one or more codestreams corresponding to text input by a user. ASCII code is not limited to English characters. For example, according to the ASCII code, each of Hangul (i.e., Korean alphabet) and/or related special characters is defined using a 2 byte word, even though each of English alphabet and numbers is represented using a 1 byte word, Additionally, the ASCII code defines special keys using an extended ASCII code.

As described above, in the present CDMA communication method, the length of SMS message data that can be sent at one time is limited to 80 bytes. Accordingly, for SMS messages using ASCII code, the length of a transmitted SMS message is limited due to the amount of SMS transmission data as defined by the SMS service standard, Thus, the length of an SMS message is limited to 40 characters for Hangul and special characters which require a 2 byte word for each character, and the length of an SMS message is limited to 80 characters for numbers and English characters requiring a 1 byte word for each character.

Thus, because the length of an SMS message is conventionally limited a user's desire to send a longer message cannot be satisfied. Although a method of compressing SMS message data which is larger than 80 bytes when uncompressed and exchanging with each other has been developed, however, this method requires a recipient's MS to perform a series of operations such as receiving the compressed SMS message data and decoding the compressed SMS message data to restore the original SMS message data. However, decoding the compressed data (which is more complicated than compressing the data), can consume resources and lengthen an execution time.

In the method described above, a recipient's MS performs a process of decoding compressed data. Due to this, when exchanging an SMS message, more time is required to process the SMS message. Moreover, a lengthened processing time can cause the recipient's MS to consume additional power.

### SUMMARY OF THE INVENTION

An object of the present invention is to substantially solve at least the above problems and/or disadvantages and to provide at least the advantages below. Accordingly, an object of the present invention is to provide a system and method for exchanging message data which is, longer than the length of message data regulated in a Short Messaging Service (SMS) message transmission standard.

Another object of the present invention is to provide a system and method for reducing a processing time of a received SMS message and for reducing power consumption of a recipient's mobile station (MS).

According to one aspect of the present invention, there is provided a method exchanging an SMS message, the method including compressing, by a sender's MS. SMS message data which can be edited and/or formed by the sender; receiving, by a base transceiver station (BTS) which communicates with the sender's MS, the compressed SMS message data and transmitting the compressed SMS message data to a BTS communicating with a recipient's MS based on the compressed SMS message data: receiving, by the BTS communicating with the recipient's MS, the compressed SMS message data and restoring the compressed SMS message data to the SMS message data; and transmitting, by the BTS communicating with the recipient's MS, the restored SMS message data to the recipient's MS.

According to one aspect of the present invention, there is provided a system for exchanging an SMS message, the system including a sender's MS for compressing SMS message data edited and/or formed by the sender; a BTS, which is connected to the sender's MS, for receiving the compressed SMS message data and transmitting the compressed SMS message data to a BTS connected to a recipient's MS based on the compressed SMS message data; the BTS, which is connected to the recipient's MS, for receiving the compressed SMS message data, restoring the SMS message data, and transmitting the restored SMS message data to the recipient's MS; and the recipient's MS for receiving the restored SMS message data and displaying it to the recipient.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating a system for exchanging an SMS message according to a preferred embodiment of the present invention;

FIG. 2 is a block diagram illustrating a mobile Station (MS) according to a preferred embodiment of the present invention;

FIG. 3 is a flowchart illustrating a process of sending SMS message data in an MS according to a preferred embodiment of the present invention; and

FIG. 4 is a flow diagram illustrating a method of exchanging an SMS message in a system for exchanging an SMS message according to a preferred embodiment of the present invention.

### DETAILED DESCRIPTION OF THE PREFERRED EMBODIMENT

Preferred embodiments of the present invention will be described herein below with reference to the accompanying drawings. In the drawings, the same or similar elements are denoted by the same reference numerals even though they are depicted in different drawings. In the following description, well-known functions or constructions are not described in detail since they would obscure the invention in unnecessary detail.

To help full understanding of the present invention, the basic principle of the present invention will now be described. When a sender composes, forms and/or edits SMS message data which is longer than the length regulated in the SMS message transmission standard (e.g., 80 bytes), the edited SMS message data is compressed using Huffman coding. The SMS message data compressed using, for example, Huffman coding is transmitted to a base transceiver station (BTS) communicating with a sender's mobile station (MS). Then, the BTS communicating with the sender's MS transmits the compressed SMS message data to a BTS in which the location of a recipient's MS (designated by the SMS message data) is presently registered (e.g., a recipients serving BS). The BTS communicating with the recipient's MS, which has received the compressed SMS message data, restores the SMS message data by decoding the compressed SMS message data and transmits the restored SMS message data to the recipient's MS. As used herein, it should be understood that by decoding the compressed SMS message, the compressed SMS message is uncompressed.

Herein, if the compressed SMS message data is longer than the length regulated in the SMS message transmission standard (e.g. 80 bytes), the sender's MS divides the compressed SMS message data to fit the SMS message transmission standard and transmits the divided SMS message data to the BTS connected to the sender's MS. The BTS communicating with the recipient's MS, which receives the divided SMS message data, receives all the divided SMS message data and then restores the SMS message data from all the received SMS message data. The BTS communicating with the recipient's MS divides the restored SMS message data according to the SMS message transmission standard and transmits the divided SMS message data to the recipient's MS. The recipient's MS receives all the divided SMS message data, combines the received SMS message data, and displays the combined SMS message data to the recipient as a single SMS message. Thus, the sender and the recipient can easily exchange an SMS message longer than the length regulated in the SMS message transmission standard. As defined by the present invention, since the recipient's MS performs only an operation of combining a plurality of received SMS messages into a single SMS message system resources (e.g., time, power, etc.) are conserved.

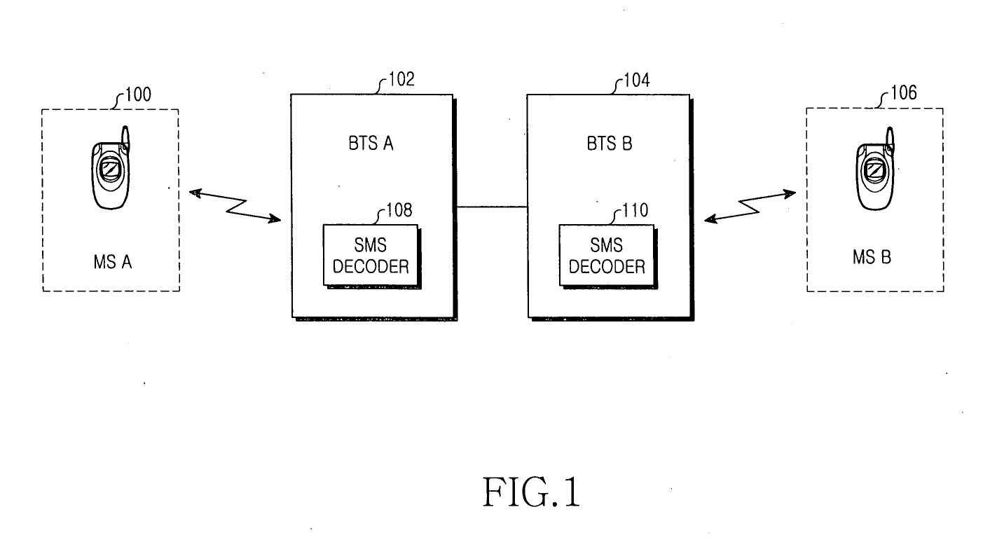

FIG. 1 is a block diagram illustrating a system for exchanging an SMS message according to a preferred embodiment of the present invention. The system includes a sender's MS 100 (hereinafter, an MS A), a BTS 102 in which the location of the MS A 100 is registered (hereinafter, a BTS A), a recipient's MS 106 (hereinafter, an MS B), and a BTS 104 in which the location of the MS B 106 is registered (hereinafter, a BTS B). Herein, of course, the BTS A 102 and the BTS B 104 may be the same BTS according to locations of the MS A 100 and the MS B 106.

Each of the BTS A 102 and the BTS B 104 typically includes a base station controller (BSC), a mobile switching center (MSC), a common command signaling No. 7, a Home location register (HLR), and a visitor location controller (VLR) and performs operations for providing various services such as a phone call service between MS users, an SMS, and a multimedia messaging service (MMS). These elements are not shown for the sake of clarity. In addition, when at least one compressed SMS message is received from the MSA 100, MSA 100 decodes the received SMS message. If it is determined that the decoded SMS message exceeds a length pre-set according to the SMS message transmission standard, the MS A 100 divides the decoded SMS message based on the pre-set length. Then, MS A 100 transmits the divided SMS messages to the MS B 106. To do this, each of the BTS A 102 and the BTS B 104 included in the system exchanging an SMS message according to a preferred embodiment of the present invention includes a respective SMS decoder 108 or 110 for restoring the SMS message by decoding the compressed SMS message.

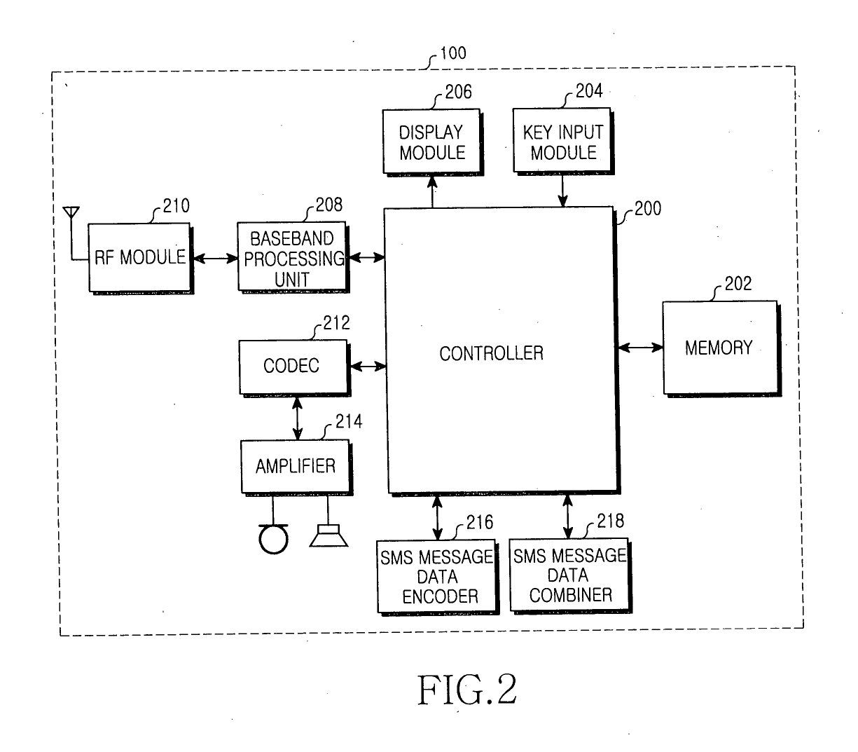

FIG. 2 is a block diagram illustrating the MS A 100 or the MS B 106 in the system for exchanging an SMS message according to a preferred embodiment of the present invention illustrated in FIG. 1. Referring to FIG. 2, in each of the MS A 100 and the MS B 106 according to a preferred embodiment of the present invention, a memory 202, a key input module 204, a display module 206, a baseband processing unit 208, a coder-decoder (CODEC) 212, a message data encoder 216, and a message data combiner 218 are connected to a controller 200. The controller 200 processes a phone call or data communication, processes a voice signal and data according to protocols for wireless Internet access, and controls components of the MSA 100 and/or the MS B 106. In addition, the controller 200 receives key inputs of a user through the key input module 204 and controls the display module 206 to generate image information corresponding to the user's key inputs and display the generated image information.

When the user edits an SMS message, the controller 200 determines whether the length of the edited SMS message exceeds the length pre-set according to the SMS message transmission standard. If the length of the edited SMS message exceeds the length pre-set according to the SMS message transmission standard, the SMS message is compressed using the message data encoder 216. If the length of the compressed SMS message exceeds the length pre-set according to the SMS message transmission standard, the compressed SMS message is divided based on the SMS message transmission standard. Then, the divided compressed SMS messages are transmitted to the MS A 100 or the MS B 106.

When an SMS message is received from the MSA 100 or the MS B 106, the controller 200 determines whether the received SMS message is one of divided SMS messages. If the controller 200 determines that the received SMS message is not one of divided SMS messages, the received SMS message is displayed using the display module 206. Alternatively, if the received SMS message is one of corresponding divided SMS messages, the controller 200 receives all the divided SMS messages and controls the message data combiner 218 to combine the divided SMS messages into one SMS message. Then, the controller 200 controls the display module 206 to display the combined single SMS message. Accordingly, users of MSs according to a preferred embodiment of the present invention can easily exchange an SMS message which is longer than the length regulated in the SMS message transmission standard without requiring extra processing time or extra power consumption which are required to restore compressed SMS message data to SMS message data.

The memory 202 connected to the controller 200 includes a Read Only Memory (ROM), a flash memory and a Random Access Memory (RAM). The ROM stores therein programs for processing and controlling of the controller 200 and various kinds of reference data. The RAM provides a working memory of the controller 200. The flash memory provides an area to store various kinds of data such as updatable storage data, etc. The controller 200 controls the message data encoder 216 to compress SMS message data by a specific coding scheme such as Huffman coding. When a plurality of divided SMS messages are received, the controller 200 controls the message data combiner 218 to combine them into a single SMS message.

As described above, the key input module 204 includes various keys such as numeric keys and provides key inputs (input by a user) to the controller 200. A radio frequency (RE) module 210 transmits/receives an RE signal to/from a BTS, In detail, the RF module 210 converts a received RE signal to an intermediate frequency (IF) signal and outputs the IF signal to the baseband processing unit 208 connected to the controller 200, and converts an IF signal input from the baseband processing unit 208 to an RF signal and transmits the converted RF signal.

The baseband processing unit 208, which can include a baseband analog ASIC (BBA) for providing an interface between the controller 200 and the RF module 210, converts a baseband digital signal to an analog IF signal and outputs the converted analog IF signal to the RF module 210, and converts an analog IF signal input from the RF module 210 to a baseband digital signal and outputs the converted baseband digital signal to the controller 200. The CODEC 212 is coupled to a microphone and a speaker via an amplifier 214, outputs to the controller 200 voice data obtained by Pulse Code Modulation (PCM) encoding a voice signal input from the microphone and outputs a voice signal obtained by PCM decoding voice data input from the controller 200 to the speaker through the amplifier 214. The amplifier 214 amplifies a voice signal input from the microphone or output to the speaker, and the controller 200 controls the amplifier 214 to adjust a speaker volume and/or a microphone gain.

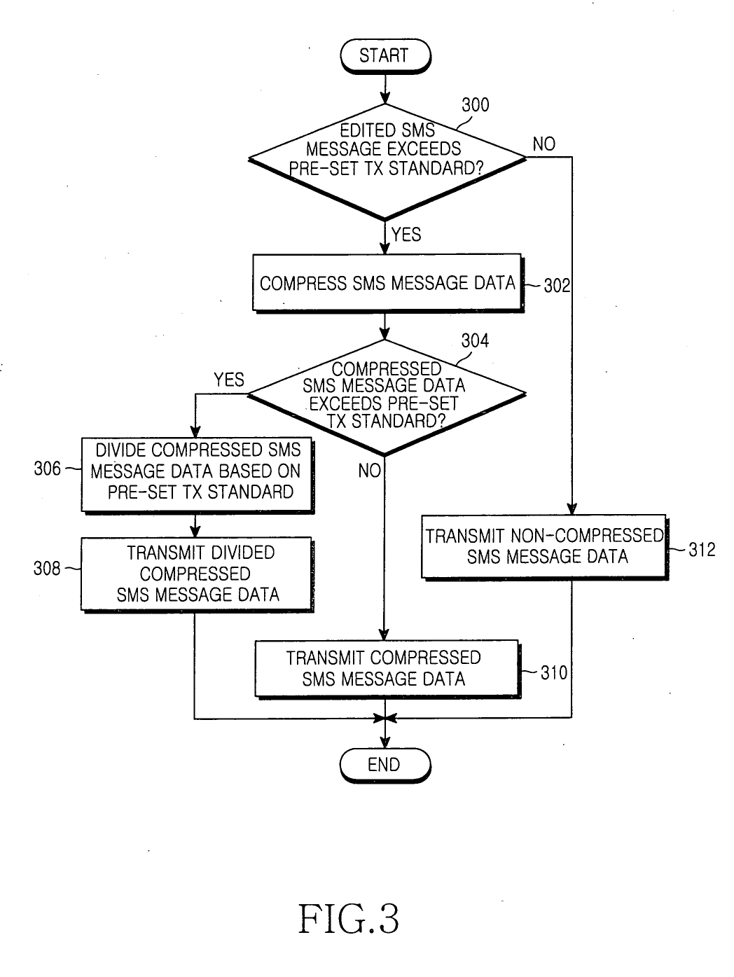

FIG. 3 is a flowchart illustrating a process of compressing and sending SMS message data in an MS according to a preferred embodiment of the present invention. Referring to FIG. 3, when a user forms and/or edits an SMS message, in step 300, the controller 200 of the MS according to a preferred embodiment of the present invention determines whether the length of the SMS message data formed and/or edited by the user exceeds a length pre-set according to the SMS message transmission standard. If it is determined in step 300 that the length of the formed and/or edited SMS message data does not exceed the length pre-set according to the SMS message transmission standard (e.g., 80 bytes), in step 312, the non-compressed SMS message is transmitted to a BTS.

If it is determined in step 300 that the length of the edited formed and/or SMS message data exceeds the length pre-set according to the SMS message transmission standard, in step 302, the controller 200 compresses the formed and/or edited SMS message data using a pre-set coding scheme. Herein, Huffman coding can be used as the scheme for compressing the SMS message data. The Huffman coding can be a compressing scheme proper to lossless compression of such small amount of data as an SMS message since the number of bits representing unit information is assigned to each unit information based on appearance frequency of each unit information and thus the quantity of bits required to represent the entire data is reduced by representing information with a high appearance frequency using a fewer bits than are used for representing information with low appearance frequency.

To describe the Huffman coding, it is assumed that the user edits an SMS message composed of 20 English characters using the characters “A”, “B”, “C”, “D”, “E”, “F”, “G”, and “H” to send the SMS message. In general, according to a statistical proportion that each character is used, if a proportion that uses “A” is 40%, a proportion that uses “B” is 20%, a proportion that uses “C” is 15%, a proportion that uses “D” is 9%, a proportion that uses “E” is 8%, a proportion that uses “F” is 5%, a proportion that uses “G” is 2%, and a proportion that uses “H” is 1%, the binary code tree structure illustrated in Table 1 can be represented according to the usage frequency of the English characters in the Huffman coding.

TABLE I

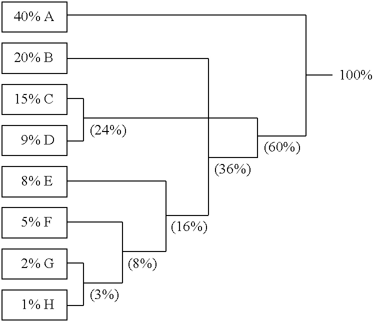

In this case, it is assumed that “A” is used eight times, “B” is used four times, “C” is used three times, each of “D” and “E” is used twice, “F” is used once, and “G” and “H” are not used in the SMS message edited by the user. In addition, in the Huffman coding, if 1 bit is allocated to “A” having the highest usage frequency and 6 bits are allocated to “G” and “H” having the lowest usage frequency, the amount of data required to represent the SMS message formed and/or edited by the user with ASCII code and Huffman code is illustrated in Table 2 below.

TABLE 2

| | Usage | ASCII | | | Huffman | |
|---|---|---|---|---|---|---|
| Character | frequency | code bits | | Huffman code | code bits | |
| A | 8 | 56(8 * 7 | bits) | 0(1 bit) | 8(8 * 1 | bit) |
| B | 4 | 28(4 * 7 | bits) | 110(3 bits) | 12(4 * 3 | bits) |
| C | 3 | 21(3 * 7 | bits) | 100(3 bits) | 9(3 * 3 | bits) |
| D | 2 | 14(2 * 7 | bits) | 101(3 bits) | 6(2 * 3 | bits) |
| E | 2 | 14(2 * 7 | bits) | 1110(4 bits) | 8(2 * 4 | bits) |
| F | 1 | 7(1 * 7 | bits) | 11110(5 bits) | 5(1 * 5 | bits) |
| G | 0 | 0(0 * 7 | bits) | 111110(6 bits) | 0(0 * 6 | bits) |
| H | 0 | 0(0 * 7 | bits) | 111111(6 bits) | 0(0 * 6 | bits) |
| Total | 20 | 140 | bits | | 48 | bits |
| Total | 20 | 140 | bits | | 48 | bits |

In Table 2, a control bit is not included in the ASCII code bits. That is, each English character can be represented using a 7 bit ASCII code which corresponds with an 8 bit ASCII code having a control bit removed from the 8 bit ASCII code. Thus, according to Table 2, while ASCII code needs 140 bits to represent the SMS message composed of 20 English characters, the SMS message can be fully represented with only 48 bits when the SMS message is compressed using the Huffman coding. In this case, a compression ratio of the SMS message in the Huffman coding is 48/140*100=34.2%. If it is assumed that the data compression ratio using the Huffman coding in a case as illustrated in Table 2 is 30% in general, when the user sends SMS message data compressed using the Huffman coding according to a preferred embodiment of the present invention, the user can send SMS message data up to 104 bytes (80 bytes+24 bytes (30% of 80 bytes)) at one time.

In step 304, the controller 200, which has compressed the SMS message data formed and/or edited by the user using a specific coding scheme such as the Huffman coding in step 302, determines whether the length of the compressed SMS message data exceeds the length pre-set according to the SMS message transmission standard. If it is determined in step 304 that the length of the compressed SMS message data does not exceed the length pre-set according to the SMS message transmission standard, in step 310, the controller 200 transmits the compressed SMS message data to the BTS.

If it is determined in step 304 that the length of the compressed SMS message data exceeds the length pre-set according to the SMS message transmission standard, in step 306, the controller 200 divides the compressed SMS message data based on the length pre-set according to the SMS message transmission standard. In step 308, the controller 200 transmits the divided compressed SMS message data to the BTS. That is, when it is assumed that the compression ratio of the Huffman coding is 30% as described above, the user can send at one time SMS message data having the up to 104-byte length that can be compressed into SMS message data having the up to 80-byte length in step 302. However, if the length of compressed SMS message data exceeds the length according to the SMS message transmission standard, which is limited to 80 bytes, the MS transmits the compressed SMS message data by dividing it. For example, if the length of SMS message data originally edited by the user is 300 bytes, the controller 200 transmits the SMS message data by dividing it into two SMS messages obtained by compressing SMS message data having a 104-byte length and one SMS message obtained by compressing SMS message data having a 92-byte length. Likewise, the user can easily exchange SMS message data exceeding the length pre-set according to the SMS message transmission standard.

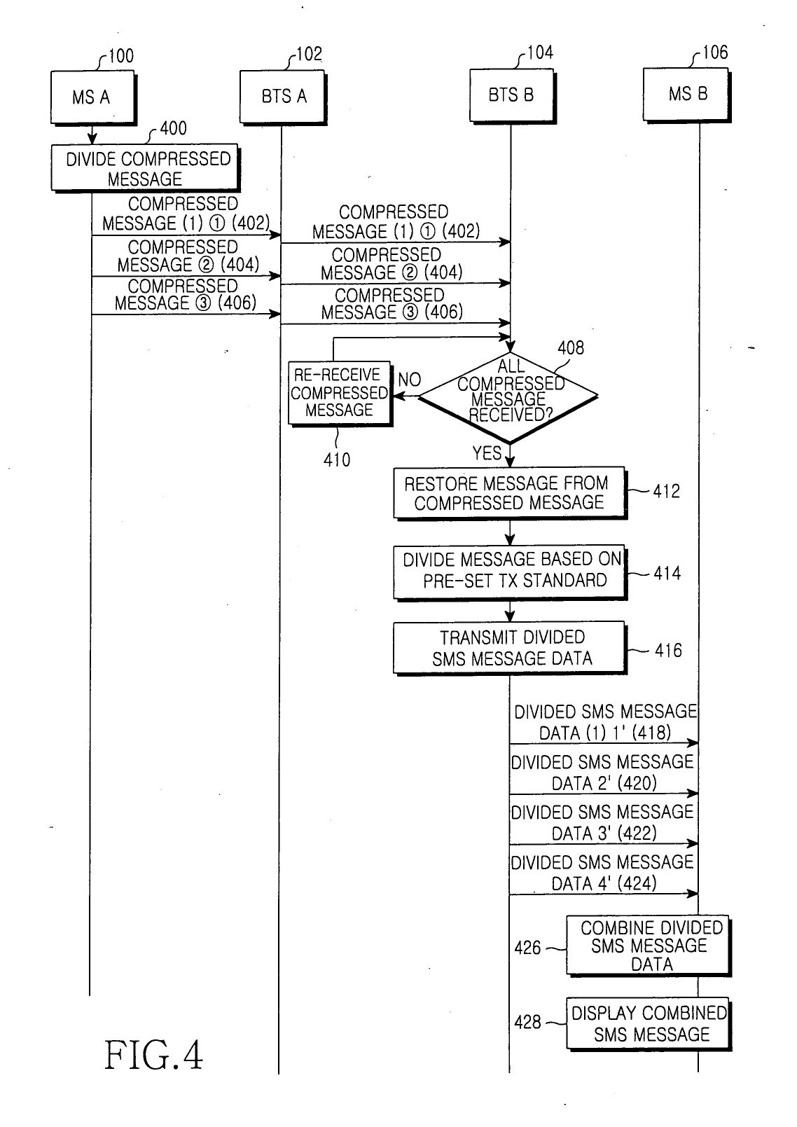

FIG. 4 is a flow diagram illustrating a process of transmitting the example illustrated in FIG 3. i.e., a 300-byte length SMS message data originally formed and/or edited by the user, from the MS A 100 to the MS B 106 in a system for exchanging an SMS message according to a preferred embodiment of the present invention. Referring to FIG. 4, in step 400, the MS A 100 compresses and divides the SMS message data originally formed and/or edited by the user and compressed in steps 302 and 306, respectively. In steps 402, 404, and 406, the MSA 100 transmits the three compressed SMS messages divided in step 400 to the BTS A 102. Then, the BTS A 102 transmits the three compressed SMS messages (each denoted by a circled numeral to the BTS B 104.

In step 408, the BTS B 104 determines whether all the divided compressed SMS messages are received. If it is determined in step 408 that all the divided SMS messages are not received, in step 410, the BTS B 104 requests the BTS A 102 to retransmit the “not received” divided compressed SMS messages, and returns to step 408 where, the BTS B 104 determines again whether all the divided compressed SMS messages are received. If it is determined in step 408 that all the divided compressed SMS messages are received, in step 412, the BTS B 104 restores the SMS message data originally formed and/or edited by the user by decoding the divided compressed SMS messages.

After completing the SMS message restoring process, in step 414, the BTS B 104 divides the restored SMS message data based on the length pre-set according to the SMS message transmission standard. That is, if the length of the SMS message data originally edited by the user is for example 300 bytes as used in this example, the length of the SMS message data restored by the BTS B 104 is also 300 bytes. Thus, in this case, in step 414, the BTS B 104 divides the restored 300-byte SMS message data based on the length pre-set by the SMS transmission standard (e.g., 80-bytes, and accordingly, the 300-byte SMS message data is divided into four SMS messages having 80 bytes, 80 bytes, 80 bytes, and 60 bytes, respectively.

In steps 418, 420, 422 and 424, the BTS B 104 transmits the SMS messages divided in step 414 to the MS B 106, These messages are illustrated by the circled numerals. In step 426, the MS B 106 combines the divided SMS messages received in steps 418 to 424 into a single SMS message. After the divided SMS messages are combined in step 428, the controller 200 of the MS B 106 displays the SMS message combined in step 426 to the user using the display module 206. Thus the users of the MS A 100 and the MS B 106 can easily exchange SMS message data exceeding the length regulated in the SMS message transmission standard. In addition, the compressed SMS message data can be more efficiently restored and delivered by dividing and transmitting the SMS message data restored by decoding the compressed SMS message data transmitted from the MSA 100 in the BTS B 104, which can use much more abundant resources than the MS B 106.

As described above, according to embodiments of the present invention, when a sender forms and/or edits SMS message data longer than the length regulated in the SMS message transmission standard, the SMS message data is compressed using the Huffman coding and transmitted. A BTS connected to a recipient's MS, which has received the compressed SMS message data, restores the SMS message data by decoding the compressed SMS message data and transmits the restored SMS message data to the recipient's MS. Accordingly, SMS message data longer than the length regulated in the SMS message transmission standard can be easily exchanged, and compressed SMS message data can be restored and delivered without an extra processing time or extra power consumption to process the compressed SMS message data in the recipient's MS.

While the invention has been shown and described with reference to a certain preferred embodiment thereof, it will be understood by those skilled in the art that various changes in form and details may be made therein without departing from the spirit and scope of the invention. In particular, while it has been assumed that a BTS communicating with a sender's MS is separate from a BTS communicating a recipient's MS in preferred embodiments, the BTSs can be the same BTS. In addition, while it has been illustrated in preferred embodiments that a length regulated in the SMS message transmission standard is 80 bytes, if the SMS message transmission standard is changed, of course the length of SMS message data to be compressed and divided according to the invention will be changed. Therefore, the spirit and scope of the invention will be defined by the appended claims not by the described preferred embodiments.

What is claimed is:

1. A method of exchanging a short messaging service (SMS) message, the method comprising:
compressing, by a sender's mobile station (MS), SMS message data to be transmitted;
receiving, by a base transceiver station (BTS) connected to the sender's MS, the compressed SMS message data and transmitting the compressed SMS message data to a BTS connected to a recipient's MS based on the compressed SMS message data;
receiving, by the BTS connected to the recipient's MS, the compressed SMS message data and restoring the compressed SMS message data to the SMS message data; and
transmitting, by the BTS connected to the recipient's MS, the restored SMS message data to the recipient's MS.

2. The method of claim 1, wherein the step of compressing the SMS data includes:
determining whether the SMS message data has a data length which exceeds a predetermined data length; and
compressing the SMS message data according to result of the determination.

3. The method of claim 2, wherein the predetermined data length corresponds with a data length defined by an SMS transmission standard.

4. The method of claim 2, wherein the step of compressing the SMS message data further includes:
determining whether the compressed SMS message data has a data length which exceeds the predetermined data length; and
if it is determined that the data length of the compressed SMS message data exceeds the predetermined data length, dividing the compressed SMS message data based on the predetermined data length.

5. The method of claim 4, wherein the step of transmitting the compressed SMS message data further includes:
if the compressed SMS message data is divided, transmitting the divided compressed SMS message data.

6. The method of claim 1, wherein the SMS message data is compressed using a Huffman coding scheme.

7. The method of claim 1, wherein the step of transmitting the restored SMS message data further includes:
if the restored SMS message data has a data length which exceeds a predetermined data length, dividing the restored SMS message data based on the data predetermined length; and
transmitting the divided SMS message data.

8. The method of claim 7, wherein the predetermined data length corresponds with a data length defined by an SMS transmission standard.

9. The method of claim 7, further comprising:
if the recipient's MS receives the divided SMS message data, combining all the divided SMS message data into a single SMS message.

10. A system for exchanging a short messaging service (SMS) message, the system comprising:
a sender's mobile station (MS) for compressing SMS message data to be transmitted;
a base transceiver station (BTS), which is connected to the sender's MS, for receiving the compressed SMS message data and transmitting the compressed SMS message data to a BTS connected to a recipient's MS based on the compressed SMS message data;
the BTS, which is connected to the recipient's MS, for receiving the compressed SMS message data, restoring the SMS message data, and transmitting the restored SMS message data to the recipient's MS; and
the recipient's MS for receiving the restored SMS message data and displaying it to the recipient.

11. The system of claim 10, wherein the sender's MS includes a message data encoder for compressing the SMS message data.

12. The system of claim 11, wherein the message data encoder compresses the SMS message data using a Huffman coding scheme.

13. The system of claim 10, wherein the sender's MS, if the length of the compressed SMS message data has a data length which exceeds a predetermined data length, divides the compressed SMS message data based on the predetermined data length and transmits the divided compressed SMS message data to the BTS connected to the sender's MS

14. The method of claim 13, wherein predetermined data length corresponds with a data length defined by an SMS transmission standard.

15. The system of claim 10, wherein the BTS connected to the recipient's MS receives the compressed SMS message data and restores the SMS message data from the compressed SMS message data, divides the restored SMS message data based on the predetermined data length, and then transmits the divided SMS message data to the recipient's MS.

16. The method of claim 13, wherein predetermined data length corresponds with a data length defined by an SMS transmission standard.

17. The system of claim 15, wherein the recipient's MS receives the divided SMS message data and combines the divided SMS message data into a single SMS message.
